(19) United States
(12) Patent Application Publication
(10) Pub. No.: US 2017/0286479 A1
(43) Pub. Date: Oct. 5, 2017

(54) SYSTEM AND METHOD FOR INTELLIGENT RENAMING OR AUGMENTED NAMING BASED ON COMMON USE

(71) Applicant: International Business Machines Corporation, Armonk, NY (US)

(72) Inventors: Gary D. CUDAK, Wake Forest, NC (US); Christopher J. HARDEE, Raleigh, NC (US); Sarbajit K. RAKSHIT, Kolkata (IN); Adam ROBERTS, Moncure, NC (US)

(21) Appl. No.: 15/089,100

(22) Filed: Apr. 1, 2016

(51) Int. Cl. G06F 17/30; G06F 3/0482

(52) U.S. Cl. CPC G06F 17/30392; G06F 3/0482

(57) ABSTRACT

Method, system, and apparatus for dynamically modifying menu selection descriptions to include common use descriptions. A search query is generated that includes the menu selection description. The search query is transmitted to a remote computer system, such as a computer hosting a public search engine or a community forum. The remote computer system executes the search query and returns results. The results are parsed to identify one or more alternative menu selection descriptions that are commonly used. The menu selection description is modified to include the alternative menu selection description. When a user selects the menu for display, the modified menu selection description is displayed.

### BACKGROUND

The present invention relates to menus for electronic devices, and more specifically, to updating menu descriptions to include common usage names.

Electronic devices, such as televisions and audio-video receivers (AVRs) typically include menus that allow users to change settings. Different manufacturers may use different names for essentially the same setting. Over time, the setting may develop a commonly-used name (i.e., a generic name).

### SUMMARY

According to one embodiment of the present invention, an apparatus includes an output operable to output display signals to a display screen. The apparatus also includes computer memory that stores a plurality of menu selection descriptions. The apparatus also includes a computer processor. The apparatus also includes a computer program, stored in the computer memory, that, when executed on the computer processor, performs an operation for processing data, comprising transmitting a search query to a remote computer, wherein the search query is generated based on a first one of the plurality of menu selection descriptions. The operation also comprises parsing query results corresponding to the search query to determine at least one alternative menu selection description associated with the first one of the plurality of menu selection descriptions. The operation also comprises modifying the first one of the plurality of menu selection descriptions o include the at least one alternative menu selection description. The operation also comprises outputting to the output the modified first one of the plurality of menu selection descriptions on a menu display.

According to one embodiment of the present invention, a system for modifying menu selection descriptions of a plurality of remote electronic devices comprises a computer memory that stores a plurality of menu selection descriptions for the plurality of remote electronic devices. The system also includes a computer processor. The system also includes a computer program, stored in the computer memory, that, when executed on the computer processor, performs an operation for processing data, comprising transmitting a search query to a remote computer, wherein the search query is generated based on a first one of the plurality of menu selection descriptions. The operation also comprises parsing query results corresponding to the search query to determine at least one alternative menu selection description associated with the first one of the plurality of menu selection descriptions. The operation also comprises modifying the first one of the plurality of menu selection descriptions to include the at least one alternative menu selection description. The operation also comprises transmitting the modified first one of the plurality of menu selection descriptions to the plurality of remote electronic devices via the remote computer interface.

According to one embodiment of the present invention, a computer-implemented method comprises transmitting a search query to remote computer, wherein the search query is based on a first one of a plurality of menu selection descriptions. The computer-implement method also comprises parsing query results corresponding to the search query to determine at least one alternative menu selection description associated with the first one of the plurality of menu selection descriptions. The computer-implement method also comprises modifying the first one of the plurality of menu selection descriptions in the electronic device to include the at least one alternative menu selection description. The computer-implement method also comprises outputting for display the modified first one of the plurality of menu selection descriptions on a menu display for the electronic device.

### BRIEF DESCRIPTION OF THE SEVERAL VIEWS OF THE DRAWINGS

FIG. 1 is a front view of a television display screen displaying menu selections for settings for the television;

FIG. 2 is a block diagram of a system according to at least one embodiment;

FIG. 3 is a block diagram of a system according to at least one embodiment; and

FIG. 4 is a flow chart of a method for modifying a menu selection description according to at least one embodiment.

### DETAILED DESCRIPTION

In the following, reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Electronic devices, such as televisions and audio-video receivers (AVRs) typically include menus that allow users to change settings. Different manufacturers may use different names for essentially the same setting. Over time, the setting may develop a commonly-used name (i.e., a generic name). A user of the electronic device may be familiar with the commonly-used name, but not the name used by the manufacturer. As a result, the user may be confused by the menu selections based on the manufacturer-named descriptions. In embodiments described herein, an electronic device can search publicly available data, such as websites, to identify commonly-used names for menu selections. The electronic device can then update the manufacturer-named descriptions to include the commonly-used names. Such updating can minimize user confusion.

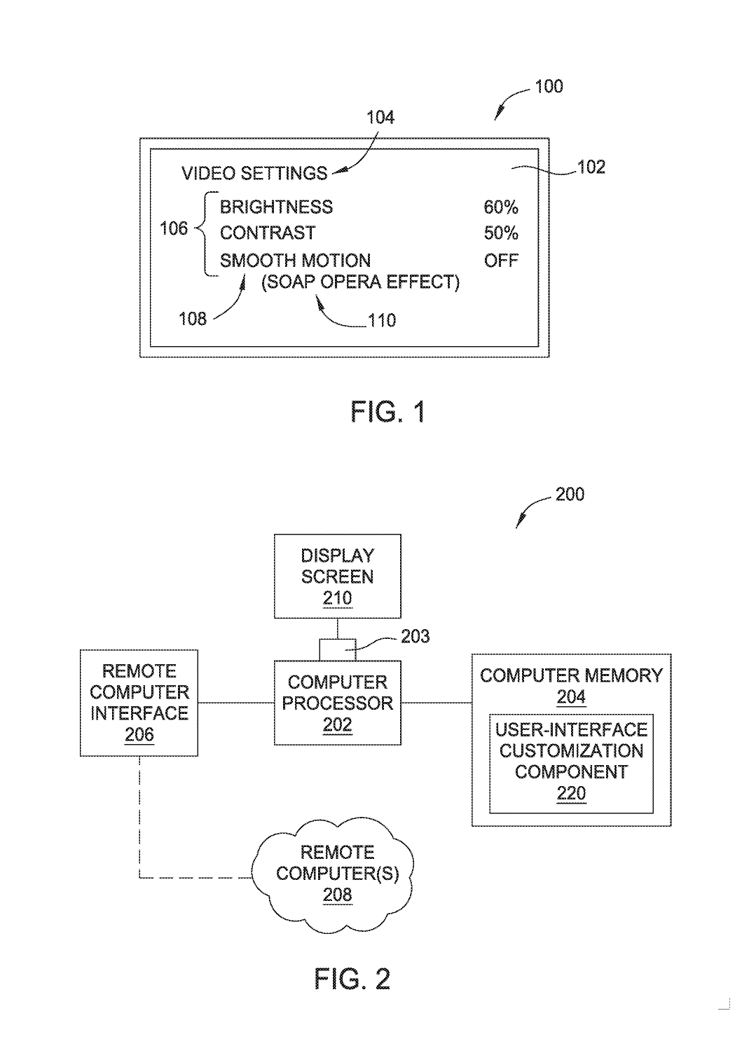

FIG. 1 illustrates a television 100, such as a liquid crystal display (LCD) television, that includes a display screen 102. A settings menu 104 is being displayed on the display screen 102. The settings menu 104 is output for display on the display screen 102 by a computer processor. The settings menu 104 includes menu selection descriptions 106 for various settings that a user can adjust. In the exemplary settings menu 104 shown in FIG. 1, the menu selection descriptions 106 include a “brightness” menu selection description, a “contrast” menu selection description, and a “SmoothMotion” menu selection description 108. The “SmoothMotion” menu selection description 108 may be a proprietary name, used by the manufacturer of the television 100, for frame interpolation, in which extra video frames are calculated and added between two adjacent frames of a video source to reduce motion blur. This frame interpolation technique has become commonly known as the “soap opera effect” because video subjected to such frame interpolation can have a fake smoothness that looks like a soap opera.

A user of the television 100 may be familiar with the common use term of “soap opera effect” but may not be familiar with the “SmoothMotion” menu selection description 108. Such a user could have difficulty navigating and using the exemplary settings menu 104 illustrated in FIG. 1 because the “SmoothMotion” menu selection description 108 would not be readily understandable to the user. The user may have to consult a user manual or other offline reference to understand what the menu selection descriptions 106 in the settings menu 104 are related to. In various embodiments described herein, the television 100 or other electronic device automatically searches for alternative menu selection descriptions that are in common use. Continuing the example above, the “SmoothMotion” menu selection description 108 may be commonly referred to as the “soap opera effect.” When an alternative menu selection description is found, the computer processor outputting the settings menu 104 (or another computer processor in the television 100) could modify the relevant menu selection description to include the alternative menu selection description. For example, FIG. 1 shows the “SmoothMotion” menu selection description 108 modified to include a parenthetical alternative menu selection description 110 that states “soap opera effect.” As another example, the computer processor outputting the settings menu 104 could modify the menu selection description 108 by removing the original menu selection description and replacing it with the alternative menu selection description. Continuing the example above, the computer processor outputting the settings menu 104 could replace the “SmoothMotion” menu selection description 108 with the “soap opera effect” alternative menu selection description 110.

FIG. 2 illustrates a block diagram of an electronic device 200 that automatically searches for alternative menu selection descriptions for its own use. The electronic device 200 includes a computer processor 202 in communication with computer memory 204. The computer memory 204 stores the menu selection descriptions for the electronic device 200. The computer processor 204 is also in communication with a display screen 210 that can display, among other things, menu selection descriptions (e.g., menu selection descriptions 106) output by the computer processor 210. In the case of a television, the display screen 210 could be the television display that also displays video signals. In the case of other electronic devices, such as an audio-video receiver (AVR) or stereo amplifier, the display screen 210 could be a display screen that is dedicated to displaying the menu selection descriptions. Alternatively, the electronic device 200 could include an output 203 that is operable to output display signals such that the menu selection descriptions are output to the display screen 210 that is connected to the output 203. The processor 203 could be in communication with an output 203, and the output 203 could transmit display signals to the display screen 210. For example, an AVR may be connected to a display screen (e.g., an LCD television) via an HDMI cable or analog component video cables, and the AVR may output a graphical user interface, such as the settings menu 104, on the connected display screen 210. The computer processor 202 is also in communication with a remote computer interface 206 that enables the computer processor 202 to communicate with one or more remote computers 208. The remote computer interface could be a wired or wireless Ethernet connection, a Bluetooth® wireless connection, a cellular data connection, or other data connection.

The one or more remote computers 208 could include various computers that record, store, and/or host public forums related to a particular type of electronic device. For example, for televisions, AVRs, and other home theater devices, a remote computer 208 could be a computer server that hosts the www.aysforum.com audio-visual forum. The one or more computers 208 could also include various computers that host search engines, such as computers that host the Google® search engine, the Yahoo!® search engine, and the Bing® search engine. As described in greater detail below, software (e.g., a user-interface customization component 220 stored in the computer memory 204) executing on the computer processor 202 could generate a search query based on a menu selection description and search the one or more remote computers 208 for alternative menu selection descriptions. In the event an alternative menu selection description is found, the computer processor 202 modifies the menu selection description stored in the computer memory 204 to include the alternative menu selection description. As discussed above with respect to FIG. 1, the software executing on the computer processor 202 could modify the menu selection description such that the original menu selection description and the alternative menu selection description are both output for display or the software could automatically replace the original menu selection description with the alternative menu selection description.

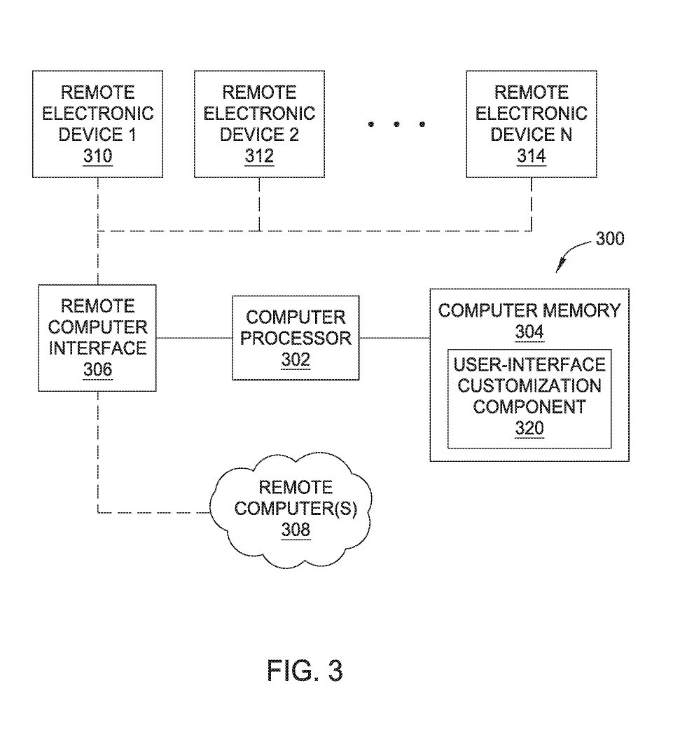

FIG. 3 illustrates a block diagram for a computer server 300 that automatically searches for alternative menu selection descriptions for use by electronic devices 310, 312, and 314. For example, rather than having individual televisions search for alternative menu selection descriptions, computer software (e.g., operated by the manufacturer of the television) executing on a computer processor 302 of the server 300 could search for alternative menu selection descriptions. The computer server 300 includes the computer processor 302 in communication with computer memory 304. The computer memory 304 stores menu selection descriptions for the various electronic devices 310, 312, and 314. The computer processor 302 is also in communication with a remote computer interface 306 that enables the computer processor to communicate with one or more remote computers 308. The remote computer interface could be a wired or wireless Ethernet connection, a Bluetooth® wireless connection, a cellular data connection, or other data connection.

The one or more remote computers 308 could include various computers that record, store, and/or host public forums related to a particular type of electronic device. For example, for televisions, AVRs, and other home theater devices, a remote computer could be a computer server that hosts the www.aysforum.com audio-visual forum. The one or more computers 308 could also include various computers that host search engines, such as computers that host the Google® search engine, the Yahoo!® search engine, and the Bing® search engine. As described in greater detail below, software (e.g., a user-interface customization component 320 stored in the computer memory 304) executing on the computer processor 302 could generate a search query based on a menu selection description and search the one or more remote computers 308 for alternative menu selection descriptions. In the event an alternative menu selection description is found, the computer processor 302 modifies the menu selection description stored in the computer memory 304 to include the alternative menu selection description. As discussed above with respect to FIG. 1, the computer processor 302 could modify the menu selection description such that the original menu selection description and the alternative menu selection description are both output for display or could replace the original menu selection description with the alternative menu selection description.

The remote computer interface 306 also communicates with the various remote electronic devices 310, 312, and 314. In one example, the various remote electronic devices 310, 312, and 314 are televisions manufactured by a manufacturer operating the computer server 300. The televisions could be the same model or different models being operated by customers. Many consumer electronic devices, such as televisions, AVRs, and Blu Ray® disc players, are “smart” devices that include Internet connectivity for connection to various online services, such as streaming video services and software updates. The computer server 300 could communicate with such “smart” remote electronic devices 310, 312, and 314 using the remote computer interface 306 to push the modified menu selection description to the various remote electronic devices 310, 312, and 314. For example, the computer processor 302 could periodically transmit a ping signal to the remote electronic devices 310, 312, and 314 to determine whether the devices are online. If a particular remote electronic device is online (e.g., turned on and capable of communicating with the remote computer interface 306), then the remote electronic device can respond to the ping signal. Upon the computer processor 302 receiving a response to the ping signal, the computer processor 302 can communicate with the particular remote electronic device to determine whether the particular remote electronic device has received any modified menu selection descriptions that are stored in the computer memory 304. If the particular remote electronic device has not received the modified menu selection description, then the computer processor 302 can transmit the modified menu selection descriptions to the particular remote electronic device via the remote computer interface 306.

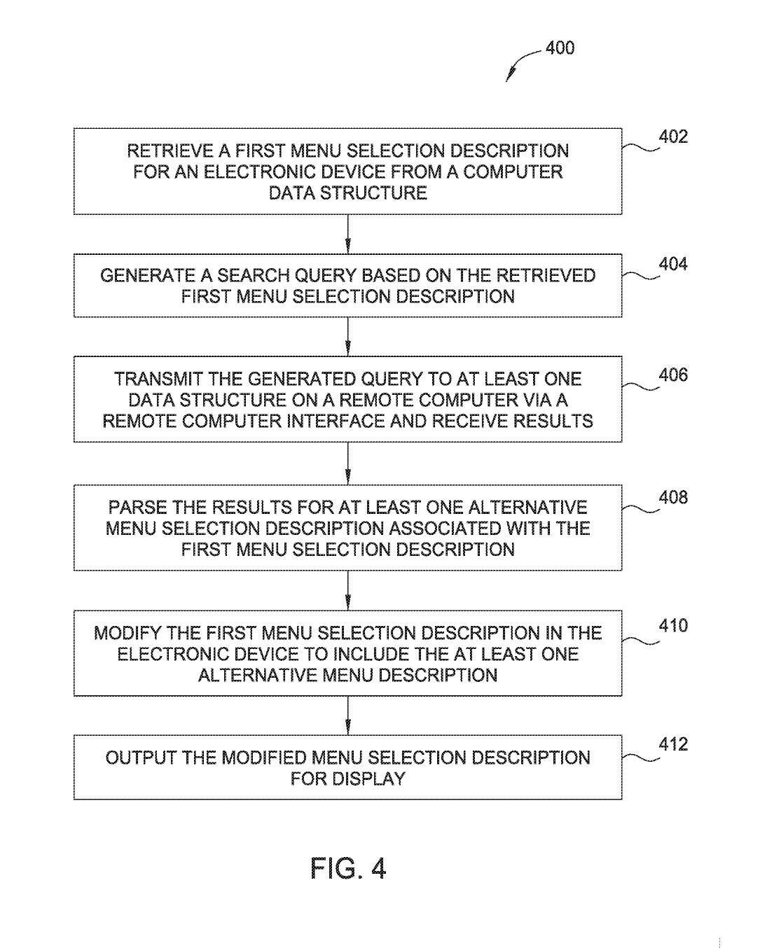

FIG. 4 is a flow chart for a process 400 according to at least one embodiment in which a computer processor (e.g., computer processor 202 in FIG. 2 or computer processor 302 in FIG. 3) modifies menu selection descriptions. In block 402 of the process 400, the computer processor retrieves a first menu selection description for an electronic device from a computer data structure. For example, the computer processor 202 in FIG. 2 could retrieve a “SmoothMotion” menu selection description from a computer data structure stored in computer memory 204 or the computer processor 304 in FIG. 3 could retrieve a “SmoothMotion” menu selection description from a computer data structure stored in computer memory 304.

In block 404, the computer processor generates a search query based on the retrieved first menu selection description. In various embodiments, the search query could include the first menu selection description. For example, the search query could be the term “SmoothMotion.” In instances in which the first menu selection description includes multiple words (e.g., “frame interpolation”), the search query could be formatted to preserve the ordering of the search terms (e.g., include quotation marks surrounding the multiple words such that the words are searched for in order and without intervening words or punctuation between the multiple words). In various aspects, the search query could include one or more phrases that may be found in search results that associate the first menu selection description with a common use name. For example, a search query for the “SmoothMotion” menu selection description 108 could include the term “SmoothMotion” in conjunction with one or more of the phrases “what is,” “also known as,” and “referred to.” In various embodiments, the search query could also include the make and/or model of the electronic device using the menu selection description.

In block 406, the generated search query is transmitted to a remote computer database management system hosting a data structure and results from the search query are received via the remote computer interface. As discussed above, in some instances, the remote data structure on a remote computer could be the stored contents of a particular public electronic forum related to an electronic device that uses the menu selection description. As discussed above, an exemplary public electronic forum relevant to televisions is www.aysforum.com. In this exemplary scenario, the computer processor (e.g., computer processor 202 or computer processor 302) transmits the search query (e.g., via the remote computer interface 206 or the remote computer interface 306) to a computer server hosting and the data structure that stores the contents of www.aysforum.com. The www.aysforum.com domain includes a built-in search function that could implement the search query. The computer processor (e.g., computer processor 202 or computer processor 302) receives the results of the search query via the remote computer interface (e.g., remote computer interface 206 or remote computer interface 306). As another exemplary scenario, the computer processor transmits the search query to a search engine, such as Google.com and receives the results of the search query via the remote computer interface.

In block 408, the software executing on the computer processor (e.g., computer processor 202 or computer processor 302) parses the received results to identify at least one alternative menu selection description associated with the first menu description. In at least one embodiment, parsing the data includes counting instances in which possible alternative menu selection descriptions appears in the search results and identifying the possible alternative menu selection description with the most instances as the alternative menu selection description or with a number of instances that exceeds a predetermined threshold number of instances. In such embodiments, pronouns, verbs, adverbs, and articles may be ignored or excluded from the counting. In various embodiments, parsing the data includes identifying alternative menu selection descriptions that appear in the same sentence or the same paragraph as the first menu selection description. For example, the computer processor could locate periods to identify sentences within a returned search result and could locate carriage returns to identify paragraphs within the returned search result. In at least one embodiment, parsing the data includes identifying an alternative menu selection description that appears in a sentence with the first menu description and a predetermined phrase that indicates an association therebetween, such as “also known as” or “referred to.” For example, continuing the exemplary scenario described above, a page from www.aysforum.com that is returned as a search result may include a sentence that reads: “SmoothMotion is also referred to as the soap opera effect.” The exemplary sentence includes the first menu description (i.e., “SmoothMotion), a predetermined phrase (i.e., “referred to”), and other words. After ignoring the verbs, adverbs, pronouns, and articles, the remaining words are “soap opera effect.”

In block 410, after at least one alternative menu selection description has been identified, the computer processor (e.g., computer processor 202 or computer processor 302) modifies the first menu selection description to include the alternative menu selection description. For example, the computer processor 202 could modify the first menu selection description by adding the alternative menu description to the entry for the first menu selection description in the data structure stored in computer memory 204. As another example, the computer processor 202 could modify the first menu selection description by replacing the first menu selection description in the data structure with the alternative menu selection description.

In at least one embodiment, the computer processor (e.g., computer processor 202 or computer processor 302) could prompt a user to select an alternative menu selection description from the at least one alternative menu selection description. In the event the at least one alternative menu selection description includes more than one alternative menu selection descriptions, the computer processor could prompt the user with a list of the alternative menu selection descriptions. The user could select the desired alternative menu selection description from the list. In response, the computer processor could modify the first menu selection description by replacing the first menu selection description with the alternative menu selection description selected by the user.

In at least one embodiment, a user's preferred alternative menu selection descriptions could be stored in a user profile. The user profile could be transmitted to other devices that are owned and/or controlled by the user. For example, with reference to FIG. 3, a user could have two televisions at home. If the user has set up a user profile for the first television (i.e., remote electronic device 1 310) that includes at least one preferred alternative menu selection description, the user profile could be transmitted to the server 300 for storage on computer memory 304. If the user is identified by the second television (e.g., if the user enters a username and password associated with the user profile), then the computer processor 302 of the server 300 could automatically upload the user profile and the preferred alternative menu selection descriptions to the second television (e.g., remote electronic device 2 312).

In block 412, the computer processor outputs the modified menu selection description for display. For example, the computer processor 202 outputs the modified menu selection description for display on the display screen 210. FIG. 1 illustrates an example of a television 100 in which the modified “SmoothMotion” menu selection description 108 includes the alternative “soap opera effect” menu selection description 110 as a parenthetical. As another example, the computer processor 302 outputs the modified menu selection description to the remote electronic devices 310, 312, and 314 such that the remote electronic devices 310, 312, and 314 can subsequently display the modified menu selection on associated displays.

The process 400 described in FIG. 4 can be performed dynamically such that later changes to common names applied to various menu selection descriptions can be incorporated into electronic devices. Continuing the exemplary scenario above, at a first instance in time, the parsed results of the search query for “SmoothMotion” menu selection description resulted in an alternative menu selection description of “soap opera effect” and the “SmoothMotion” menu selection description was modified to include “soap opera effect.” As more time passes, the term “soap opera effect” could fall out of common use and in favor of a different term. For example, it is possible that frame interpolation could be commonly called “frame adding” in the future and websites and other data structures hosted on remote computers (e.g., remote computers 208 and 308) would include references to “frame adding.” In such an exemplary scenario, a subsequent operation of the process 400 described above with reference to FIG. 4 could result in a new alternative menu selection description of “frame adding” that replaces or is added to “soap opera effect.” In such a subsequent operation of the process 400, the original menu selection description (i.e., “SmoothMotion”) and/or the first alternative menu selection description (i.e., “soap opera effect”) could be used to generate the search query in block 404.

In various embodiments, the frequency with which the menu selection descriptions can be modified can be limited. For example, the process 400 for modifying the menu selection descriptions could be performed once per week, once per month, once every six months, once per year, or some other suitable interval.

Referring again to FIG. 3, in embodiments in which a computer server 300 can communicate with remote electronic devices 310, 312, and 314, inputs made by users to the electronic devices 310, 312, and 314 could provide alternative menu selection descriptions. In many instances, remote electronic devices (e.g., electronic devices 310, 312, and 314) provide users with the option of customizing labels. For example, a television may allow a user to change a generic label for an input from “INPUT 1” to “CABLE BOX” or “SATELITE DISH.” The user may select a provided label (e.g., “CABLE BOX”) or may manually enter a custom label (e.g., “COMCAST”®). Continuing the exemplary scenario above, if the menu selection descriptions are customizable, then a certain number of users of the remote electronic devices 310, 312, and 314 may modify the “SmoothMotion” menu selection description 108 to read “soap opera effect.” Such modifications could be transmitted to the computer processor 302 of the computer server 300. If the “SmoothMotion” menu selection description has been modified to “soap opera effect” on a certain number (or percentage) of remote electronic devices, then the software executing on the computer processor 302 could modify the “SmoothMotion” menu selection description 108 in the data structure stored in the computer memory 304 to include the “soap opera effect” alternative menu selection description. The computer processor 302 could then transmit the modified menu selection description to all of the remote electronic devices 310, 312, and 314.

In various circumstances, different common usages may apply to different types of users. For example, television consumers may commonly use the term “soap opera effect” for frame interpolation whereas home theater installers may commonly use the term “frame adding.” In various embodiments, an electronic device may store multiple modified menu selection descriptions and select for display a modified menu selection description associated with a user profile. Continuing the example above, televisions sometimes have two menus: a consumer menu and an “expert” menu. The consumer menu offers basic adjustments to the consumer whereas the “expert” menu offers additional adjustments that require special expertise, training, and/or calibration tools to use. Such a television could include the “SmoothMotion” menu selection description 108 and could store two modified menu selection descriptions. A first modified menu selection description could state “soap opera effect” and a second modified menu selection description could state “frame adding.” When the consumer menu is displayed, the first modified menu selection description of “soap opera effect” can be displayed. When the “expert” menu is displayed, the second modified menu selection description of “frame adding” can be displayed. As another example, a user could self identify as an expert or non-expert (e.g., through a menu setting) and the suitable modified menu selection descriptions could be provided based on the self-identification.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present invention, a user may access applications (e.g., a menu selection description modification application) or related data available in the cloud. For example, the menu selection description modification application could execute on a computing system in the cloud and provide modified menu selection descriptions. In such a case, the menu selection description modification application could generate the search query based on a menu selection description (block 402 in FIG. 4), transmit the search query and receive results (block 404), parse the results to identify at least one alternative menu selection description (block 406), and modify the menu selection description to include the alternative menu selection description (410). The menu selection description modification application could then store the modified menu selection description at a storage location in the cloud. Doing so allows a user to access this information from any computing system attached to a network connected to the cloud (e.g., the Internet).

While the foregoing is directed to embodiments of the present invention, other and further embodiments of the invention may be devised without departing from the basic scope thereof, and the scope thereof is determined by the claims that follow.

What is claimed is:

1. An apparatus, comprising:
an output operable to output display signals to a display screen;
computer memory that stores a plurality of menu selection descriptions;
a computer processor; and
a computer program, stored in the computer memory, that, when executed on the computer processor, performs an operation for processing data, comprising:
transmitting a search query to a remote computer, wherein the search query is generated based on a first one of the plurality of menu selection descriptions;
parsing query results corresponding to the search query to determine at least one alternative menu selection description associated with the first one of the plurality of menu selection descriptions;
modifying the first one of the plurality of menu selection descriptions o include the at least one alternative menu selection description; and
outputting to the output the modified first one of the plurality of menu selection descriptions on a menu display.

2. The apparatus of claim 1, wherein the search query includes a model identification for the apparatus and the first one of the plurality of menu selection descriptions, wherein transmitting the generated query to at least one remote data structure comprises transmitting the generated query to an Internet-based search engine such that the Internet-based search engine returns documents relevant to the generated query; and wherein an at least one alternative menu selection description is associated with the first one of the plurality of menu selection descriptions when the alternative menu selection description simultaneously appears with the first one of the plurality of menu selection descriptions on more than a threshold number of the returned documents.

3. The apparatus of claim 2, wherein an at least one alternative menu selection description is associated with the first one of the plurality of menu selection descriptions when the alternative menu selection description simultaneously appears within the same paragraph as the first one of the plurality of menu selection descriptions on more than a threshold number of the returned documents.

4. The apparatus of claim 2, wherein an at least one alternative menu selection description is associated with the first one of the plurality of menu selection descriptions when the alternative menu selection description simultaneously appears within the same sentence as the first one of the plurality of menu selection descriptions on more than a threshold number of the returned documents.

5. The apparatus of claim 1, wherein the computer memory stores an electronic user guide for selective display on the display screen, and wherein the processor modifies an explanation of the first menu selection to include the alternative menu selection description in the electronic user guide.

6. The apparatus of claim 1, wherein the received results are parsed for at least two alternative menu selection descriptions, wherein each of the at least two alternative menu selection descriptions is associated with a different user profile, and wherein the computer processor is further operable to:
receive a selection of a user profile; and
modify the first one of the plurality of menu selection descriptions in the electronic device to include the alternative menu selection description associated with the selected user profile.

7. The apparatus of claim 1, further comprising the display screen operable to display the modified menu selection.

8. A system for modifying menu selection descriptions of a plurality of remote electronic devices, comprising:
a computer memory that stores a plurality of menu selection descriptions for the plurality of remote electronic devices;
a computer processor; and
a computer program, stored in the computer memory, that, when executed on the computer processor, performs an operation for processing data, comprising:
transmitting a search query to a remote computer, wherein the search query is generated based on a first one of the plurality of menu selection descriptions;
parsing query results corresponding to the search query to determine at least one alternative menu selection description associated with the first one of the plurality of menu selection descriptions;
modifying the first one of the plurality of menu selection descriptions to include the at least one alternative menu selection description; and
transmitting the modified first one of the plurality of menu selection descriptions to the plurality of remote electronic devices via the remote computer interface.

9. The system of claim 8, wherein the computer processor transmits the modified first one of the plurality of menu selection descriptions to a first one of the plurality of remote electronic devices upon receiving an indication that the first one of the plurality of remote electronic devices is in communication with the remote computer interface.

10. The system of claim 8, wherein menu selection descriptions of the plurality of remote electronic devices can be selectively modified by users of the menu selection descriptions, wherein the computer processor is further operable to receive menu selection descriptions that have been modified by the users via the remote computer interface and to create a second modified first menu selection description for the plurality of remote electronic devices that includes a menu selection description that has been modified by users on at least a predetermined threshold number of the plurality of remote electronic devices, and wherein the computer processor is further operable to transmit the second modified menu selection description to the plurality of remote electronic devices via the remote computer interface.

11. The system of claim 8, wherein the modified first one of the plurality of menu selection descriptions is associated with a first user profile, wherein the computer processor is further operable to create a modified second menu selection description for the plurality of remote electronic devices that includes a second alternative menu selection description from the at least one alternative menu selection description, wherein the computer processor is operable to transmit the modified first menu selection to a first one of the plurality of remote electronic devices associated with the first user profile, and wherein the computer processor is operable to transmit the modified second menu selection description to a second one of the plurality of remote electronic devices associated with the second user profile.

12. The system of claim 8, wherein the search query includes a model identification for the remote electronic devices and the first one of the plurality of menu selection descriptions, wherein transmitting the generated query to at least one remote data structure comprises transmitting the generated query to an Internet-based search engine such that the Internet-based search engine returns documents relevant to the generated query; and wherein an at least one alternative menu selection description is associated with the first one of the plurality of menu selection descriptions when the alternative menu selection description simultaneously appears with the first one of the plurality of menu selection descriptions on more than a threshold number of the returned documents.

13. The system of claim 12, wherein an at least one alternative menu selection description is associated with the first one of the plurality of menu selection descriptions when the alternative menu selection description simultaneously appears within the same paragraph as the first one of the plurality of menu selection descriptions on more than a threshold number of the returned documents.

14. The system of claim 8, wherein the received results are parsed for at least two alternative menu selection descriptions, wherein each of the at least two alternative menu selection descriptions is associated with a different user profile, and wherein the computer processor is further operable to:
receive a selection of a user profile for each of the plurality of remote electronic devices;
generate modified first menu selection descriptions in the electronic device that include the different alternative menu selection descriptions associated with the received selections of user profiles; and
transmit the respective modified first menu selection descriptions to the remote electronic devices based on the received selections of user profiles from the remote electronic devices.

15. A computer-implemented method, comprising:
transmitting a search query to remote computer, wherein the search query is based on a first one of a plurality of menu selection descriptions;
parsing query results corresponding to the search query to determine at least one alternative menu selection description associated with the first one of the plurality of menu selection descriptions;
modifying the first one of the plurality of menu selection descriptions in the electronic device to include the at least one alternative menu selection description; and
outputting for display the modified first one of the plurality of menu selection descriptions on a menu display for the electronic device.

16. The method of claim 15, wherein the search query includes a model identification for the apparatus and the first one of the plurality of menu selection descriptions, wherein transmitting the generated query to at least one remote data structure comprises transmitting the generated query to an Internet-based search engine such that the Internet-based search engine returns documents relevant to the generated query; and wherein an at least one alternative menu selection description is associated with the first one of the plurality of menu selection descriptions when the alternative menu selection description simultaneously appears with the first one of the plurality of menu selection descriptions on more than a threshold number of the returned documents.

17. The method of claim 16, wherein an at least one alternative menu selection description is associated with the first one of the plurality of menu selection descriptions when the alternative menu selection description simultaneously appears within the same paragraph as the first one of the plurality of menu selection descriptions on more than a threshold number of the returned documents.

18. The method of claim 16, wherein an at least one alternative menu selection description is associated with the first one of the plurality of menu selection descriptions when the alternative menu selection description simultaneously appears within the same sentence as the first one of the plurality of menu selection descriptions on more than a threshold number of the returned documents.

19. The method of claim 15, wherein parsing the received results includes identifying an alternative menu selection description that appears most frequently in the results, and associating the identified alternative menu selection description with the first one of the plurality of menu selection descriptions.

20. The method of claim 15, wherein the received results are parsed for at least two alternative menu selection descriptions, wherein each of the at least two alternative menu selection descriptions is associated with a different user profile, the method further comprising:
receive a selection of a user profile; and
modify the first menu selection description in the electronic device to include the alternative menu selection description associated with the selected user profile.
